(19) United States
(12) Patent Application Publication
(10) Pub. No.: US 2004/0171355 A1
(43) Pub. Date: Sep. 2, 2004

(54) Wireless transceiver for implantable medical devices

(75) Inventors: Chih-Hsiung Yu, Taoyuan City (TW); Shyhliang Lou, Hsinchu City (TW); Jang-Tzeng Lin, Hsinchu City (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/736,567

(22) Filed: Dec. 17, 2003

(30) Foreign Application Priority Data
Dec. 31, 2002 (TW) 091138155

(51) Int. Cl. H04B 1/44

(52) U.S. Cl. 455/78; 455/41.2

(57) ABSTRACT

The present invention is concerned with a wireless transceiver for implantable medical devices, and has a first coil winding wound around its coil axis in a first direction, at least one second coil winding wound around its coil axis in a second direction non-parallel with the first direction, and at least one circuit board having at least one control circuit; wherein the first and the second coil windings are electrically connected to the control circuit of the circuit board respectively.

### BACKGROUND OF THE INVENTION

1. Field of the Invention

The present invention relates to a wireless transceiver for medical devices. More particularly, the present invention relates to a wireless transceiver for implantable medical devices (IMD).

2. Description of Related Art

Micro-processing technology has currently matured to minimize a medical instrument for implanting into a human body. In this respect, research for implantable medical devices has been made over the past decade so that a clinical application of the implantable medical devices has gradually become acceptable throughout the medical world. For example, active implantable medical devices such as an implantable electrical nerve stimulator or a blood glucose sensor are available for medical application now. However, an implantable electrical nerve stimulator or a blood glucose sensor requires a power supply for operation. Although a battery can be used as a supplier of electrical power, the lifetime of the electrical power of battery is too short to be well suited to the aforesaid implantable devices. Hence, a wireless transmission device is alternatively adopted for supplying the power. Referring to FIG. 1, a schematic view of a conventional implantable medical device is shown. However, the receiving coil of the conventional implantable device is required to be parallel with a transmitting coil to maximize the power received as the wireless power is transmitted. If the receiving coil is perpendicular to the transmitting coil, the refueling of power is not enough. The decreased power supply through the inadequate wireless transmission probably results in abnormal operation of the implantable device. The present invention is thus provided to overcome this problem.

At present, since only one receiving coil is provided in the implantable medical devices, the improvement of the design of the implantable medical devices focuses on and is limited by its systematic structure, arrangement and function. A known implantable stimulator with a multi-channel electrode system capable of transmitting back a stimulating response to an external controller has been proposed. This known implantable stimulator uses an uni-directional antenna. Other commercial transceiver elements for electrical nerve stimulators are also available now. Similarly, they also adopt uni-directional antennas. Furthermore, implantable micro-stimulators and a method therefor have been provided in research reports. Again, the micro-stimulator uses an uni-directional antenna. Recently, an implantable medical device adopting an external charging coil has been developed. This device also uses a directional antenna. As such, providing an invention for a receiving antenna capable of normal operation and charge without being limited by an access angle of the antenna has hitherto remained unsolved.

### SUMMARY OF THE INVENTION

It is therefore a primary object of the present invention to provide an implantable receiving antenna capable of receiving signals coming from a power supply in all directions so as to have an input of electrical signal or power in all directions, to dispense with or lessen limitation of input at a predetermined direction, and to improve the existing problem of poor reception as a result of the use of the directional antenna.

To attain the aforesaid object, a wireless transceiver for implantable medical devices according to the present invention comprises a first coil winding wound around its coil axis in a first direction, at least one second coil winding wound around its coil axis in a second direction non-parallel with the first direction, and at least one circuit board having at least one control circuit; wherein the first and the second coil windings are electrically connected to the control circuit of the circuit board respectively.

As described above, the present invention is provided primarily to solve the functional incapability of the unidirectional antenna in receiving signals at an angle more than a predetermined degree (narrow angle). Multiple receiving coils in the wireless transceiver are used to solve the directional problem of narrow reception angle, keeping the implantable devices functioning normally all the time. Moreover, all the implantable devices can work normally when one or more implantable device is used at a time without any concern arising from the aforementioned direction problem. Thus, operators can easily use these medical devices with the wireless transceiver of the present invention for transmitting electrical signals and for supplying enough electrical power. Of course, an effective and desired therapy can be easily achieved through the assistance of the medical devices with the wireless transceiver of the present invention.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of coil windings of a conventional implantable medical device;

FIG. 2 is a schematic view of a first embodiment according to the present invention; and

FIG. 3 is a schematic view of a second embodiment according to the present invention.

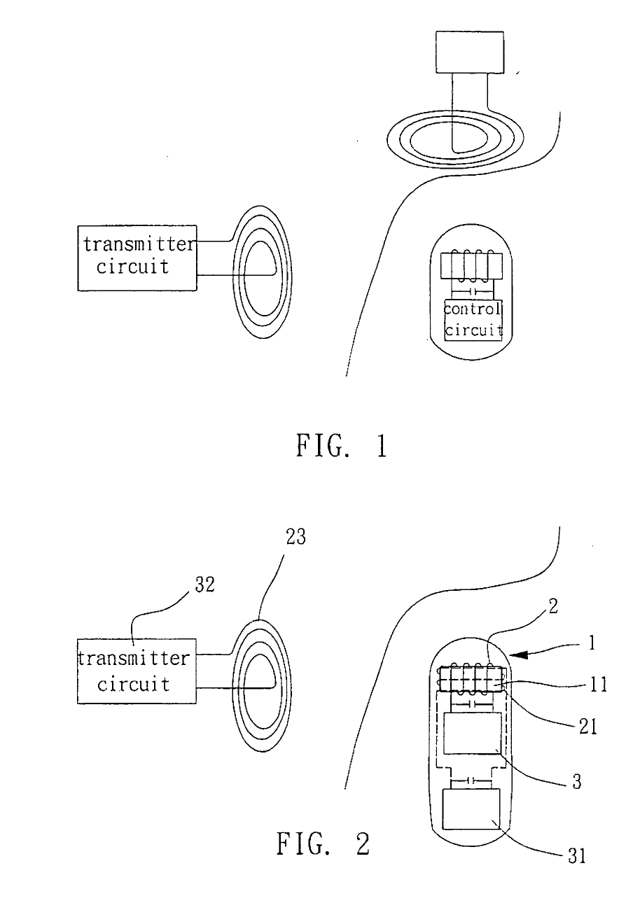

### DETAILED DESCRIPTION OF THE PREFERRED EMBODIMENT

The following will describe two embodiments of the present invention by referring to the attached drawings.

FIG. 2 shows a schematic view of a first embodiment of the present invention. An implantable medical device 1 implanted into the human body comprises a magnetic sensor 11, a first coil winding 2, a second coil winding 21, a first control circuit 3, and a second control circuit 31; wherein the magnetic sensor 11 includes a first coil axis around which the first coil winding 2 electrically connected to the first control circuit 3 is wound, and a second coil axis around which the second coil winding 21 electrically connected to the second control circuit 31 is wound. The implantable medical device is adapted to cooperate with an antenna set kit including a RF antenna set 23 and a transmitter circuit 32 for controlling the antenna set 23.

As illustrated in the present embodiment, the first and the second coil windings 2, 21 having respective coil axes orthogonal to each other are used to increase the telemetry range of the medical device, as compared with the conventional implantable medical devices with limitations of reception to signal direction. As shown in FIG. 2, signals coming from the RF antenna set 23 are primarily received by means of the first coil winding 2. When the RF antenna set 23 approaches the medical device 1 at an angle perpendicular to the first coil winding 2 and thus becomes ineffective, the second coil winding 21 begins to serve as a supplement for receiving signals. Hence, the medical device 1 can function normally without being ineffective due to limitation of reception to the angle of RF signals.

Although the present embodiment adopts two coil windings to fully cope with a two-dimensional interaction of the RF antenna set with the receiver under the normal circumstances, a third coil winding can be added if a three-dimensional interaction of the RF antenna set with the receiver occurs. The third coil winding has a third coil axis orthogonal to not only the first coil axis but also the second coil axis to compensate for any insufficient reception area caused by the additional dimension. Moreover, the arrangement or the connection of the circuit illustrated above is merely an example of circuit design by using the first coil winding 2 and the second coil winding 21 to control the first control circuit 3 and the second control circuit 31 respectively. A circuit design having both the first coil winding and the second coil winding electrically connected to the first control circuit can also be adopted as an alternative.

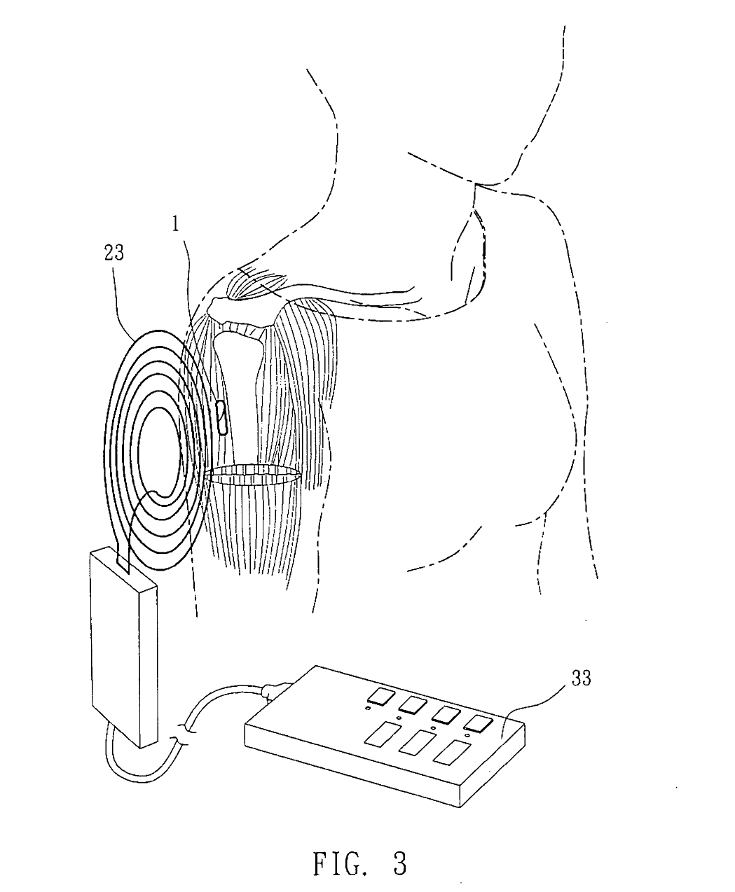

Reference is next made to FIG. 3, which is a schematic view of a second embodiment of the present invention. Similar to the first embodiment, in the present embodiment, a medical device 1 having two coil windings for reception is implanted into the human body. Moreover, a controller 33 having a third control circuit is included in the antenna set kit having the RF antenna set 23 and the transmitter circuit as described in the first embodiment. The controller 33 is capable of regulating various functions such as radiating power, radiating frequency, radiating intervals of time and space . . . etc., and can be regulated according to the user's needs.

It is noted that the magnetic sensor 11 is not a necessary element for the present invention, which however is preferably adopted to increase reception gain of the coil windings. The magnetic sensor 11 can be made of any material capable of generating an electromagnetic induction effect, and preferably, it is made of a ferrite core or an equivalent material having high permeability. Preferably, the first coil axis of the magnetic sensor 11 and the coil axis of the first coil winding are oriented in the same direction; and also, the second coil axis of the magnetic sensor 11 and the coil axis of the second coil winding are oriented in the same direction. The first coil axis and the second coil axis of the magnetic sensor are not parallel, and preferably, the first coil axis is orthogonal to the second coil axis. The magnetic sensor 11 may include three coil axes disposed in a manner of three orthogonal axes functioning as a three-dimensional structure having the x-axis, y-axis and z-axis. In addition to the first and the second coil windings, a third coil winding wound around a third coil axis can be added. The material of the first coil winding is not specifically defined, and preferably, it is an enamel wire or an equivalent conducting wire having an isolation layer. The material of the second coil winding is not specifically defined, and preferably, it is an enamel wire or an equivalent conducting wire having an isolation layer. Preferably, the first coil winding is electrically connected to the first control circuit while the second coil winding is electrically connected to the second control circuit; or alternatively, both the first and the second coil windings are electrically connected to either the first control circuit or the second control circuit.

Although the present invention has been explained in relation to its preferred embodiments, it is to be understood that many other possible modifications and variations can be made without departing from the spirit and scope of the invention as hereinafter claimed.

What is claimed is:

1. A wireless transceiver for implantable medical devices, comprising:
a first coil winding wound around its coil axis in a first direction;
at least one second coil winding wound around its coil axis in a second direction non-parallel with said first direction; and
at least one circuit board having at least one control circuit;
wherein said first and said second coil windings are electrically connected to said control circuit of said circuit board respectively.

2. The wireless transceiver of claim 1, further comprising a magnetic sensor having a first coil axis and at least a second coil axis non-parallel with said first coil axis; wherein said first coil winding is wound around said first coil axis of said magnetic sensor while said second coil winding is wound around said second coil axis of said magnetic sensor.

3. The wireless transceiver of claim 2, wherein said magnetic sensor is made of a ferrite core.

4. The wireless transceiver of claim 1, wherein said first coil axis and said second coil axis are disposed in an orthogonal manner.

5. The wireless transceiver of claim 2, wherein two said second coil axes are provided, and said second coil axes are disposed not only orthogonal to each other but also orthogonal to said first coil axis.

6. The wireless transceiver of claim 5, wherein two said second coil windings are provided, and said second coil windings are wound around said two second axes on said magnetic sensor respectively.

7. The wireless transceiver of claim 1, wherein said first coil winding is electrically connected to said control circuit.

8. The wireless transceiver of claim 6, wherein said second coil winding is electrically connected to said control circuit.

9. The wireless transceiver of claim 1, wherein said control circuit includes a first control circuit and a second control circuit.

10. The wireless transceiver of claim 9, wherein said first coil winding is electrically connected to said first control circuit.

11. The wireless transceiver of claim 10, wherein said second coil winding is electrically connected to said second control circuit.

12. The wireless transceiver of claim 1, further comprising an antenna set having a RF antenna set and a transmitter circuit for controlling the action of said RF antenna set.

13. The wireless transceiver of claim 12, wherein said antenna set further comprises a controller having a third control circuit for controlling said transmitter circuit.

14. The wireless transceiver of claim 1, wherein the number of circles of said first coil winding corresponds to the number of circles of said second coil winding.
